(19) United States
(12) Patent Application Publication
(10) Pub. No.: US 2017/0295215 A1
(43) Pub. Date: Oct. 12, 2017

(54) AUDIENCE TARGETED FILTERING OF CONTENT SECTIONS

(71) Applicant: MICROSOFT TECHNOLOGY LICENSING, LLC, Redmond, WA (US)

(72) Inventor: Masroor Hussain Syed, Redmond, WA (US)

(73) Assignee: MICROSOFT TECHNOLOGY LICENSING, LLC, Redmond, WA (US)

(21) Appl. No.: 15/093,764

(22) Filed: Apr. 8, 2016

(51) Int. Cl. H04L 29/06

(52) U.S. Cl. CPC H04L 65/602; H04L 65/4069

(57) ABSTRACT

Audience targeted filtering of content sections is disclosed. A content filter application initiates operations to provide content filtering based on a detected audience upon receiving a request to provide a content. The content includes audio/video streams and/or text based content, among others. Next, an audience category to provide the content is identified. If the content is available for priori analysis, the content is analyzed to detect section(s) of the content to filter based on the determined audience category and associated filtering rules, and results of the analysis are provided. If the content is not available for priori analysis, the associated filtering rules are applied to detect the section(s) of the content to filter. Furthermore, the filtered content is provided to the display device.

### BACKGROUND

Data collection, management, and analysis have changed work processes associated product management Automation and improvements in work processes have expanded scope of capabilities offered by businesses. With the development of faster and smaller electronics execution of mass processes at data analysis systems have become feasible, indeed, analysis work at data centers, data warehouses, data workstations have become common business features in modern work environments. Such systems execute a wide variety of applications ranging from enterprise resource management applications to complicated analysis tools. Many such applications provide content for consumption by an audience.

Vast amount of content complicate consumption and watching patterns by audiences, indeed, sheer number and variety of content make screening for objectionable material difficult if not near an impossible task. While managing content, an additional layer of complication faced by content consumption products include compliance with audience restrictions. Complications with content screening prevent reliable implementation of content consumption solutions.

### SUMMARY

This summary is provided to introduce a selection of concepts in a simplified form that are further described below in the Detailed Description. This summary is not intended to exclusively identify key features or essential features of the claimed subject mailer, nor is it intended as an aid in determining the scope of the claimed subject matter.

Embodiments are directed to audience targeted filtering of content sections. In some examples, a content filter application executed in a computing device may initiate operations to filter content sections upon receiving a request to provide a content through a display device. Next, an audience category to provide the content may be identified. If the content is available for priori analysis, the content may be analyzed to detect section(s) of the content to filter based on the determined audience category and associated filtering rules, and provide results of the analysis. If the content is not available for priori analysis, the associated filtering rules may be applied to detect the section(s) of the content to filter. Furthermore, the filtered content may be provided to the display device.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1A through 1B are conceptual diagrams illustrating examples of providing audience targeted filtering of content sections, according to embodiments;

FIG. 2 is a display diagram illustrating an example of a scheme to filter content based on audience(s), according to embodiments;

FIG. 3 is a display diagram illustrating an example of customizing a scheme to filter content based on interaction(s) with the audience and/or external source(s), according to embodiments;

FIG. 4 is a display diagram illustrating components of an application to filter content based on an audience, according to embodiments;

FIG. 5 is a simplified networked environment, where a system according to embodiments may be implemented;

FIG. 6 is a block diagram of an example computing device, which may be used to provide audience targeted filtering of content sections, according to embodiments; and

FIG. 7 is a logic flow diagram illustrating a process for providing audience targeted filtering of content sections, according to embodiments.

### DETAILED DESCRIPTION

As briefly described above, a content filter application may be provided to filter content sections based on an audience. In an example scenario, the content filter application may receive a request to provide a content through a display device. The display device may be a stand-alone device or a component of a competing device executing the content filter application. The content may be prepared for streaming and/or delivery to the display device. The content may include a video stream, an audio stream, and/or a text based content, among others.

Next an audience category to stream the content may be identified. The audience category may include one or more consumers within an age range. For example, children ages 5-15 may constitute the audience. Furthermore, if the content is available for priori analysis, the content filter application may analyze the content to detect section(s) of the content to filter based on the determined audience category and associated filtering rules, and provide results of the analysis. The section(s) may include a section of the content that may be inappropriate or undesirable for the audience.

If the content is not available for priori analysis, the associated filtering rules may be applied to detect the section(s) of the content to filter. The filtering rules may describe a start time and a duration of a section to skip. The filtered content may be provided to the display device. The filtered content may be streamed and/or delivered to the display device.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognise that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide audience targeted filtering of content sections. Examples of platforms include, but are not limited to, a hosted service executed over a plurality of servers, an application, executed on a single comparing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with text, audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

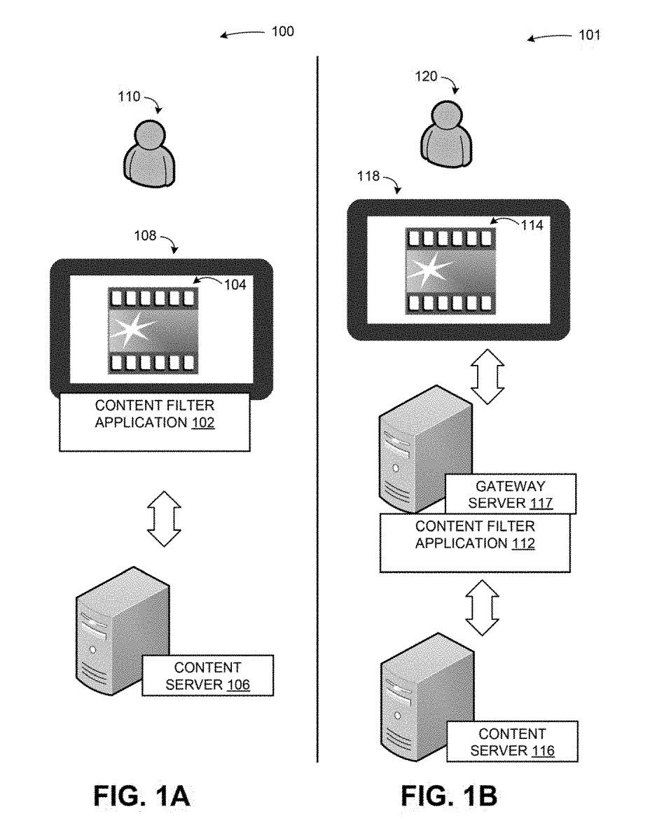

FIG. 1A through 1B are conceptual diagrams illustrating examples of providing audience targeted filtering of content sections, according to embodiments.

In a diagram 100, a computing device 108 may execute a content filter application 102. Examples of the content filter application 102 may include a media player application, a content management application, and/or a firewall application, among others. The computing device 108 may include a tablet device, a laptop computer, a desktop computer, and a smart phone, among others. The computing device 108 may include a special purpose computing device configured to provide content filter through a communication component configured to interface with component(s) and other computing device(s), a filtering component configured to analyze and filter section(s) of the content, and a presentation component configured to generate interaction(s) with component(s) and other computing device(s).

The computing device 108 may display a client interface of the content filter application 102 to an audience category 110. The audience category 110 may consume a content 104 such as an audio stream, a video stream, and/or a text based content, among others. The client interface of the content filter application 102 may display the content 104 to the audience or forward the content 104 that is processed to filter inappropriate or undesirable sections, to a media player application. The audience category 110 may also interact with the client interface of the content filter application 102 to configure and/or update content filter(s) associated with the audience category. The content filter(s) may include rule(s) to filter the content based on a property of the audience category 110 or filtering information associated with the content 104. Furthermore, the content 104 may be stored locally by the computing device 108 or retrieved from a content server 106. Example of the content server 106 may include a video provider, an audio provider, a social networking provider, a personal content source, and/or a work content source, among others.

The computing device 108 may communicate with the content server 106 through a network. The network may provide wired and/or wireless communications between nodes such as the computing device 108, and/or the content server 106, among others.

Alternatively, in a diagram 101, a gateway server 117 may execute the content filter application 112. An audience category 120 may interact with a computing device 118 to request a content 114. The content 114 may be retrieved from a content server 116. The gateway server may be situated between the computing device 118 and external sources, such as the content server 116, to filter interactions between the computing device 118 and the external sources. The gateway server 117 may execute operations to analyze the content 114 based on the audience category 120 and filter section(s) of the content 114 that are inappropriate or undesirable for the audience category 120. The gateway server 117 may also serve to filter other content for other computing devices and act as a filter for content reaching the computing device 118 and group of other device(s). Example of a gateway server 117 may include a firewall implemented by an individual, a group, an organization, and/or a political entity (such as a nation), among others.

The audience category 110 may interact with the client interface of the content filter application 102 with a keyboard based input, a mouse based input, a voice based input, a pen based input, and a gesture based input, among others. The gesture based input may include one or more touch based actions such as a touch action, a swipe action, and a combination of each, among others.

While the example systems in FIG. 1A through 1B have been described with specific components including the computing device 108, the content filter application 102, embodiments are not limited to these components or system configurations and can be implemented with other system configuration employing fewer or additional components.

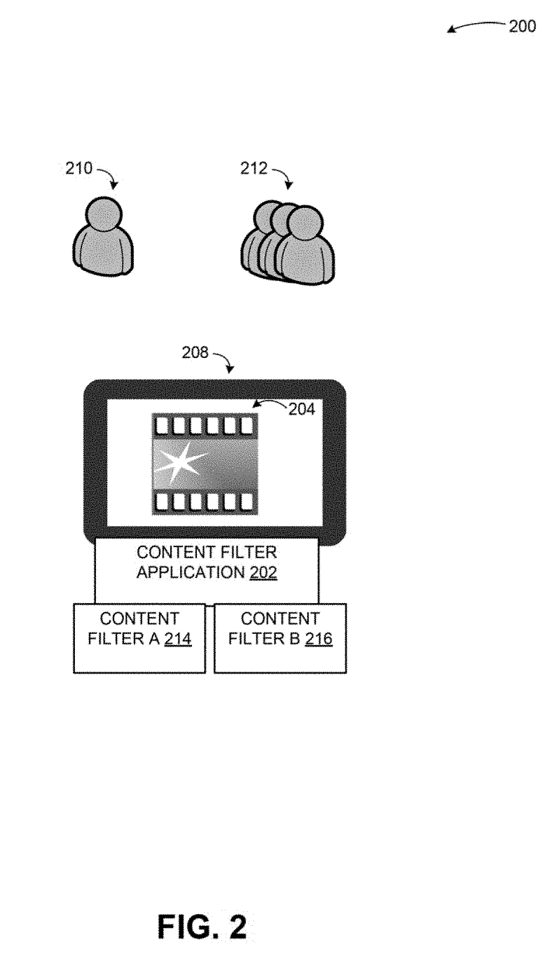

FIG. 2 is a display diagram illustrating an example of a scheme to filter content based on audience(s), according to embodiments.

In a diagram 200, a content filter application 202 may initiate operations to filter content sections based on a targeted audience upon receiving a request to provide a content 204 to an audience category 210 from a computing device 208. An example of the audience category 210 may include one or more individuals that are within an age range such as children between 6-15, young adults between 16-25, adults between 26-55, and/or elderly between 56-100, among others. The audience category 210 may also be composed of a mixed age set of individuals such as a family, a group, and/or co-workers, among others.

The computing device may execute the content filter application 202. Alternatively, the content filter application 202 may be executed in a content management server that filters content prior to delivery to the audience category 210 through the computing device 208. The content filter application 202 may analyze the content 204 for section(s) to filter in real-time while streaming the content 204 to the computing device 208. Or the content 204 may be analyzed wholly or partially and delivered to the computing device 208, wholly or partially, with filter rules may be applied to the content 204 to skip section(s) recognized as inappropriate or undesirable for the audience category 210.

The content filter application 202 may also identify the audience category 210 to stream the content 204. In an example scenario, an account information associated with an account (for example: an account associated with a member of the audience category 210) associated with the request may be retrieved. An age of a requester of the content 204 may be identified from the account information (for example: the account information may list the age of the requester). Next, the audience category 210 may be selected based on the age of the requester. The age may be within an age range associated with the audience category 210. In an example scenario, the consumer may be identified as a 17 year old. The content filter application 202 may select the audience category 210 associated with young adults from 16-25 years.

A content filler A 214 may be selected based on the age range associated with the audience category. The content filter A 214 may include rules to skip or replace section(s) of the content based on a type of the sections. The type may include an adult section, obscene word(s), a tragic section, an improper theme, and/or counter audience value(s), among others. An external source may provide filter information associated with the content 204 that may describe type(s) of the section(s) along with a start time and a duration of the section(s). Alternatively, recognition schemes such as image, optical character, object, and/or action, among others may be used to identity the section(s) including a type, a start time, and/or a duration of the section(s). The content filter application 202 may apply the content filter A 214 to filter the section(s) objectionable to the audience category 210.

Alternatively, the content filter application 202 may receive other request to filter content 204 or other content for an audience category 212. The audience category 212 may include a different makeup than the audience category 210 such as a work group, and/or a group of friends, among others. The content filter application 202 may identify one or more common properties associated with the audience category 212 such as an age range of the members of the audience category 212 or common belief system, culture, familiarity, personal relationship, and/or work relationship, among others. The content filter application 202 may select a content filter B 216 that matches the common property associated with the audience category 212. The content 204 may be processed with the content filter B 216 to filter section(s) identified by the rules in the content filter B 216 as inappropriate or undesirable for the audience category 212. The content filter B 216 may be applied to the content 204 to filter the section(s) that are undesirable and/or inappropriate to the audience category 212.

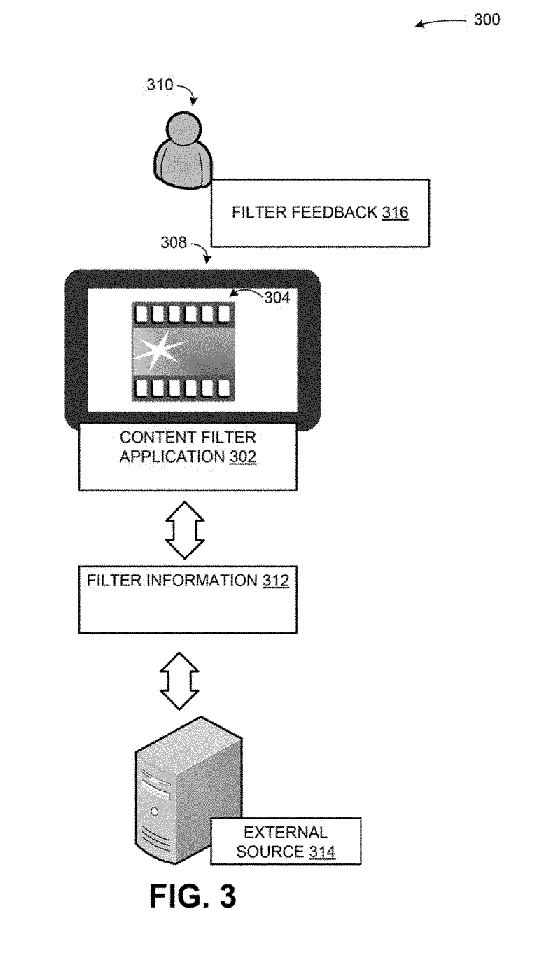

FIG. 3 is a display diagram illustrating an example of customizing a scheme to filter content based on interaction(s) with the audience and/or external source(s), according to embodiments.

In a diagram 300, a content filter application 302 (executed on a computing device 308) may filter a content 304 to skip or remove inappropriate or undesirable sections to an audience category 310 requesting the content 304 for streaming. The content filter application 302 may query an external source 314 for filter information 312. The external source 314 may include a content information source such as a content analysis and review web site and/or a social networking source, among others.

The content filter application 302 may receive filtering rules associated with the audience category from the external source to be applied to the content 304. The content filter application 302 may also receive the filter information 312 from the external source 314. The filler information may include a time marker (a start time), a duration, and/or a type for each of the section(s) of the content 304 identified as inappropriate or undesirable for the audience category 310 (or other audiences). In an example scenario, rules to skip or remove the section(s) may be generated from the time marker and the duration for each of the section(s). The rules may applied to the content 304.

Alternatively, the section(s) to skip may be identified based on a type of a section that may be inappropriate or undesirable for the audience category 310. For example, section(s) identified with a type of nudity may be marked as inappropriate or undesirable for the audience category 310. The content filter application 302 may match the audience category 310 to a type of section(s) marked as inappropriate or undesirable to the audience category 310. A subset of the section(s) with the type may be used to generate rules to skip the subset of the section(s) from a time marker and a duration associated with the subset. The rules may be applied to the content 304.

Furthermore, the content filter application 302 may provide a requestor of the content 304 (such as a member of the audience category 310) with a user experience configured to present control element(s) to provide feedback associated with section(s) of the content 304 skipped or replaced while streaming to the audience category 310. In the feedback, the requested may identify additional sections that may be marked as inappropriate or undesirable for the audience category 310. The consumer may also identify a subset of the section(s) that ruin a viewing experience by skipping the subset of the section(s). The filtering rules associated with the audience category 310 may be updated based on the feedback.

Upon receiving the feedback, the content filter application 302 may identify the additional section(s) deemed inappropriate or undeniable and the content 304 may be processed to skip or remove the additional section(s). Alternatively, the content filter application 302 may remove or disable filter rules to skip or replace a subset of the section(s) that the consumer identified as ruining the viewing experience as a result of skipping. As such, the subset of the section(s) may be displayed to the audience category 310 (or a similar audience category) in a subsequent presentation of the content 304.

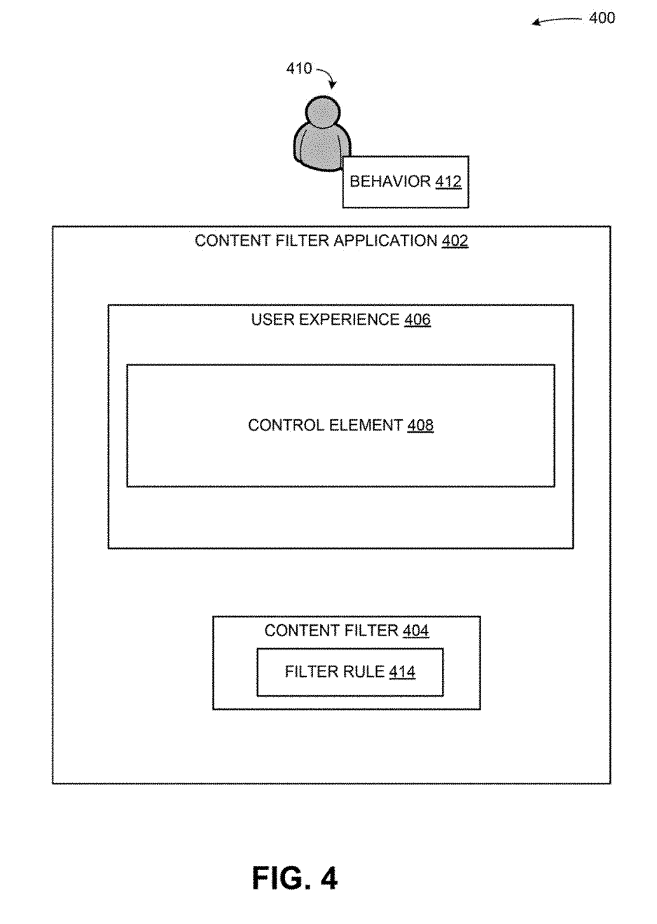

FIG. 4 is a display diagram illustrating components of an application to filter content based on an audience, according to embodiments.

In a diagram 400, a content filter application 402 may provide a consumer of a content with a user experience 406 with a control element 408 to modify a content filter 404 associated with an audience category 410. The consumer may be a member of the audience category 410 or may be an entity that manages content viewing for the audience category 410.

Next, the content filter application 402 may receive a modification associated with a filter rule 414 of the content filter 404. The content may be processed with the content filter to skip an updated set of section(s) of the content. The updated set of section(s) may be identified based on the filter rule 414 that was modified by the consumer. The filter rule 414 may be applied to a metadata associated with the content to modify the metadata to prompt an application or a device presenting the content to skip or remove the section(s) deemed inappropriate or undesirable.

Furthermore, the content filter application 402 may select the content filter 404 from a set of default filter rules that match a property associated with the audience category 410. The content filter 404 may also be configured with customized rule(s) by the audience category 410. Moreover, learned rule(s) may be used to process the content in which the filter rules are configured by a machine-learning scheme based on a behavior of the audience category 410. For example, the audience category 410 may be monitored for gestures that may deem a section of the content inappropriate such as display of a nude section. Gesture(s) by the audience category 410 to reflect inappropriateness of the nude section may be detected through a monitoring device such as a camera or a microphone. In such a scenario, filter rules may be configured to skip or replace the section and similar sections. In yet other examples, a content section may be determined to be undesirable or inappropriate for other reasons. For example, one or more persons in the audience category 410 may have recently experienced a tragedy. Based on that experience, tragic or other portions of the content that may invoke sad feelings in those audience members may be filtered.

Examples of the machine-learning scheme may include a boosted decision regression scheme, a linear scheme, a Bayesian linear scheme, a decision forest scheme, a fast forest quantile scheme, a neural network scheme, a Poisson scheme, and/or an ordinal scheme, among others. Furthermore, the content may be processed to recognize inappropriate or undesirable sections for the audience category 410 based on a recognition scheme that includes optical character recognition, voice recognition, object recognition, interaction recognition, facial recognition, and/or action recognition, among others.

As discussed above, the content filter application 402 may be employed to perform operations to automate audience targeted filtering of content sections. An increased user efficiency with the computing device 108 may occur as a result of analyzing the content to detect and skip inappropriate or undesirable sections by the content filter application 102. Additionally, processing the content to skip inappropriate or undesirable sections for an audience, by the content filler application 402, may reduce processor load, increase processing speed, conserve memory, and reduce network bandwidth usage.

Embodiments, as described herein, address a need that arises from a lack of efficiency to provide audience targeted filtering of content sections. The actions/operations described herein are not a mere use of a computer, but address results that are a direct consequence of software used as a service offered to large numbers of users and applications.

The example scenarios and schemas in FIG. 1A through 4 are shown with specific components, data types, and configurations. Embodiments are not limited to systems according to these example configurations. Audience targeted filtering of content sections may be implemented in configurations employing fewer or additional components in applications and user interfaces. Furthermore, the example schema and components shown in FIG. 1A through 4 and their subcomponents may be implemented in a similar manner with other values using the principles described herein.

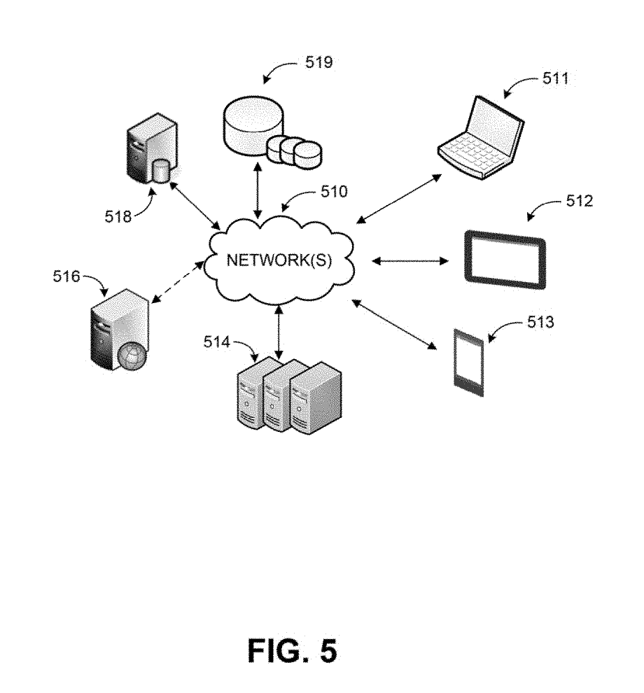

FIG. 5 is an example networked environment, where embodiments may be implemented. A content filter application 402 to filter sections of a content based on an audience may be implemented via software executed over one or more servers 514 such as a hosted service. The platform (or a custom device to execute the operations to provide audience targeted filtering of content sections) may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A content filter application may identify an audience to provide a content upon receiving a request to provide the content through a display device. Next, if the content is available for priori analysis, the content may be analyzed to detect one or more sections of the content to filter based on the determined audience category and associated filtering rules, and results of the analysis are provided to an entity that will present the content. If the content is not available for priori analysis, the associated filtering rules are applied to detect the one or more sections of the content to filter. And, the filtered content may be provided to the display device. The content filter application may store data associated with the content and the audience in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide audience targeted filtering of content sections. Furthermore, the networked environments discussed in FIG. 5 are for illustration purposes only. Embodiments are not limited to the example applications, modules, or processes.

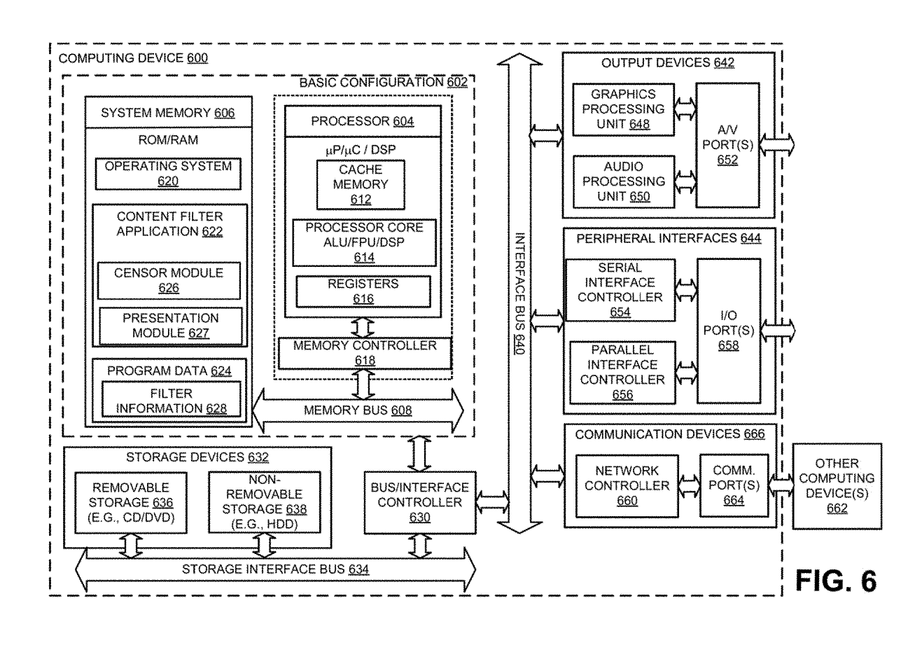

FIG. 6 is a block diagram of an example computing device, which may be used to provide audience targeted filtering of content sections, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), an application-specific integrated circuit (ASIC), a field-programmable gate array (FPGA), programmable logic device (PLD), a free form logic on an integrated circuit (IC) or other or any combination thereof. The processor 604 may include one or more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a content filter application 622, and a program data 624. The content filter application 622 may include components such as a filter module 626 and a presentation module 627. The filter module 626 and the presentation module 627 may execute the processes associated with the content filter application 622. The filter module 626 may identify an audience to provide a content upon receiving a request to provide the content through a display device. Next, if the content is available for priori analysis, the content may be analyzed to detect one or more sections of the content to filter based on the determined audience category and associated filtering rules, and results of the analysis are provided to an entity that will present the content. If the content is not available for priori analysis, the associated filtering rules are applied to detect the one or more sections of the content to filter. The presentation module 627 may provide the filtered content to the display device.

Input to and output out of the content filter application 622 may be transmitted through a communication device associated with the computing device 600. An example of the communication device may include a networking device that may be communicatively coupled to the computing device 600. The networking device may provide wired and/or wireless communication. The program data 624 may also include, among other data, filter information 628, or the like, as described herein. The filter information 628 may include a start time (or a marker), a duration, and a type associated with section(s) of the content, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devises 662 may include sewers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivers media. A “modulated data signal” may be a signal that has one of more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which, includes any of the above functions. The computing device 600 may also be implemented as a personal computer including both laptop computer and non-laptop computer configurations.

Example embodiments may also include methods to provide audience targeted filtering of content sections. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

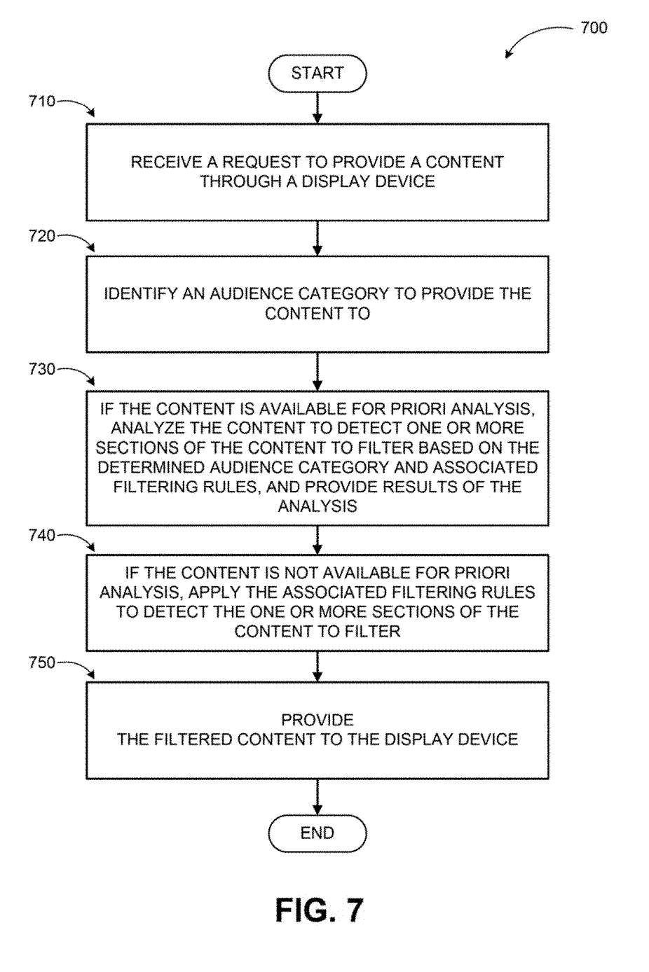

FIG. 7 is a logic flow diagram illustrating a process for providing audience targeted filtering of content sections, according to embodiments. Process 700 may be implemented on a computing device, such as the computing device 600 or another system.

Process 700 begins with operation 710, where the content filter application may recede a request to provide a content to a display device. The content may include a video stream, an audio stream, and/or a text based content, among others. At operation 720, an audience category to provide the content may be identified. The audience category may be selected based on a property of a requester of the content such as age range associated with the requester.

At operation 730, if the content is available for priori analysis, the content may be analyzed to detect one or more sections of the content to filter based on the determined audience category and associated filtering rules, and results of the analysts may be provided to an entity that may present the content. A filter with rules may be selected to identify and skip the section(s) based on a property of the audience such as the age range. At operation 740, if the content is not available for priori analysis, the associated filtering rules may be applied to the content to detect the section(s) of the content to filter. The filtered content may be provided to the display device at operation 750.

The operations included in process 700 are for illustration purposes. Audience targeted filtering of content sections may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a computing device to provide audience targeted filtering of content sections is described. The computing device includes a communication device and a memory configured to store instructions associated with a content filter application, and one or more processors coupled to the memory and the communication device. The processor(s) execute the content filter application in conjunction with the instructions stored in the memory a memory configured to store instructions associated with a content filter application. The content filter application includes a filter module and a presentation module. The filter module is configured to receive, through the communication device, a request to provide a content through a display device, identify an audience category to provide the content to, if the content is available for priori analysis, analyze the content to detect one or more sections of the content to filter based on the determined audience category and associated filtering rules, and provide results of the analysis, if the content is not available for priori analysis, apply the associated filtering rules to detect the one or more sections of the content to filter. The presentation module is configured to provide, through the communication device, the filtered content to the display device.

In other examples, the filter module is configured to identify the audience category by: retrieval of an account information associated with an account associated with the request, identification of an age of a requestor of the content from the account information, and selection of the audience category based on the age of the requestor, where the age is within an age range of the audience category. The filter module is further configured to select a content filter based on the age range associated with the audience category, the content filter including one or more rules to skip or replace the one or more sections of the content based on a type of the one or more sections that is inappropriate or undesirable for the audience category and apply the content filter to the content.

In further examples, the filter module is further configured to transmit a query to an audience member of the content to select the audience category and receive a response from the audience member, where the response includes a selection of the audience category. The audience member is a requester of the content. The filter module is further configured to query an external source for filter information associated with the content and receive the associated filtering rules from the external source. The filter module is further configured to query an external source for filter information associated with the content, where the filter information includes a time marker, a duration, and a type for each of the one or mot e sections, identify a subset of the one or more sections to be filtered using a content filter associated with the audience category based on the type described by the content filter, and generate the associated filtering rules to filter the content from the time marker and the duration for each of the subset of the one or more sections.

In other examples, the filter module is further configured to provide a requestor of the content with a user experience configured to present one or more control elements to modify a filtering rule associated the audience category, receive a modification to update the filtering rule from the requestor, and process the content with the updated filtering rule to skip or replace an updated set of the one or more sections of the content. The filter module is further configured to provide a requestor of the content with a user experience to present one or more control elements to provide feedback associated with the one or more skipped or replaced sections of the content, update the associated filtering rules based on the feedback, and identify one or more additional sections to be skipped or replaced based on the feedback.

In some examples, a method executed on a computing device to provide audience targeted filtering of content sections is described. The method includes receiving a request to provide a content through a display device, where the content includes one or more of video content, audio content, web page content, and streaming content, identifying an audience category to provide the content to, if the content is available for priori analysis, analyzing the content to detect one or more sections of the content to filter based on the determined audience category and associated filtering rules, and providing results of the analysis to a requestor of the content, if the content is not available for priori analysis, applying the associated filtering rules to detect the one or more sections of the content to filter, and providing the filtered content to the display device.

In other examples, the filtering rules are configured to cause skipping or replacement of one or more of an adult section, an obscene word, a tragic section, an improper theme, and one or more counter audience values. Applying the associated filtering rules includes detecting the one or more sections of the content based on one or more of a default rule, a customized rule, and a learned rule based on a behavior of the audience category. The method further includes processing the content to skip or replace the one or more sections in real-time while streaming the content to the audience. The method further includes processing the content through one or more of optical character recognition, voice recognition, object recognition, facial recognition, and action recognition to detect the one or more sections. The method further includes processing the content through a machine-learning scheme to detect the one or more sections, where the machine-learning scheme includes one or more of a boosted decision regression scheme, a linear scheme, a Bayesian linear scheme, a decision forest scheme, a fast forest quantile scheme, a neural network scheme, a Poisson scheme, and an ordinal scheme.

In some examples a computer-readable memory device with instructions stored thereon to provide audience targeted filtering of content sections is described. The instructions include actions similar to the actions of the method. The instructions further include applying the associated filtering rules to metadata associated with the content.

In some examples, a means for provide audience targeted filtering of content sections is described. The means for provide audience targeted filtering of content sections includes a means for receiving a request to provide a content through a display device, a means for identifying an audience category to provide the content to, if the content is available for priori analysis, a means for analyzing the content to detect one or more sections of the content to filter based on the determined audience category and associated filtering rules, and providing results of the analysis, if the content is not available for priori analysis, a means for applying the associated filtering rules to detect the one or more sections of the content to filter, and a means for providing the filtered content to the display device.

The above specification, examples and data provide a complete description of the manufacture and use of the composition of the embodiments. Although the subject matter has been described in language specific to structural features and/or methodological acts, is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide audience targeted filtering of content sections, the computing device comprising:
a communication device;
a memory configured to store instructions associated with a content filter application;
one or more processors coupled to the memory and the communication device, the one or more processors executing the content filler application in conjunction with the instructions stored in the memory, wherein the content filter application includes;
a filter module configured to:
receive, through the communication device, a request to provide a content through a display device;
identify an audience category to provide the content to;
if the content is available for priori analysis, analyze the content to detect one or more sections of the content to filter based on the determined audience category and associated filtering rules, and provide results of the analysis;
if the content is not available for priori analysis, apply the associated filtering rules to detect the one or more sections of the content to filter;
a presentation module configured to:
provide, through the communication device, the filtered content to the display device.

2. The computing device of claim 1, wherein the filter module is configured to identify the audience category by:
retrieval of an account information associated with an account associated with the request;
identification of an age of a requestor of the content from the account information; and
selection of the audience category based on the age of the requestor, wherein the age is within an age range of the audience category.

3. The computing device of claim 2, wherein the filter module is further configured to:
select a content filter based on the age range associated with the audience category, the content filter including one or more rules to skip or replace the one or more sections of the content based on a type of the one or more sections that is inappropriate or undesirable for the audience category; and
apply the content filter to the content.

4. The computing device of claim 1, wherein the filter module is further configured to:
transmit a query to an audience member of the content to select the audience category; and
receive a response from the audience member, wherein the response includes a selection of the audience category.

5. The computing device of claim 4, wherein the audience member is a requestor of the content.

6. The computing device of claim 1, wherein the filter module is further configured to:
query an external source for filter information associated with the content; and
receive the associated filtering rules from the external source.

7. The computing device of claim 1, wherein the filter module is further configured to:
query an external source for filter information associated with the content, wherein the filter information includes a time marker, a duration, and a type for each of the one or more sections;
identify a subset of the one or more sections to be filtered using a content filter associated with the audience category based on the type described by the content filter; and
generate the associated filtering rules to filter the content from the time marker and the duration for each of the subset of the one or more sections.

8. The computing device of claim 1, wherein the filter module is further configured to:
provide a requestor of the content with a user experience configured to present one or more control elements to modify a filtering rule associated the audience category; and
receive a modification to update the filtering rule from the requestor.

9. The computing device of claim 8, wherein the filter module is further configured to:
process the content with the updated filtering rule to skip or replace an updated set of the one or more sections of the content.

10. The computing device of claim 1, wherein the filter module is further configured to:
provide a requestor of the content with a user experience to present one or more control elements to provide feedback associated with the one or more skipped or replaced sections of the content; and
update the associated filtering rules based on the feedback.

11. The computing device of claim 10, wherein the filter module is further configured to:
identify one or more additional sections to be skipped or replaced based on the feedback.

12. A method executed on a computing device to provide audience targeted filtering of content sections, the method comprising:
receiving a request to provide a content through a display device, wherein the content includes one or more of video content, audio content, web page content, and streaming content;
identifying an audience category to provide the content to;
if the content is available for priori analysis,
analyzing the content to detect one or more sections of the content to filter based on the determined audience category and associated filtering rules, and
providing results of the analysis to a requestor of the content;
if the content is not available for priori analysis, applying the associated filtering rules to detect the one or more sections of the content to filter;
providing the filtered content to the display device.

13. The method of claim 12, wherein the filtering rules are configured to cause skipping or replacement of one or more of an adult section, an obscene word, a tragic section, an improper theme, and one or more counter audience values.

14. The method of claim 12, wherein applying the associated filtering rules comprises:
detecting the one or more sections of the content based on one or more of a default rule, a customized rule, and a learned rule based on a behavior of the audience category.

15. The method of claim 12, further comprising:
processing the content to skip or replace the one or more sections in real-time while streaming the content to the audience.

16. The method of claim 12, further comprising:
processing the content through one or more of optical character recognition, voice recognition, object recognition, facial recognition, and action recognition to detect the one or more sections.

17. The method of claim 12, further comprising:
processing the content through a machine-learning scheme to detect the one or more sections, wherein the machine-learning scheme includes one or more of a boosted decision regression scheme, a linear scheme, a Bayesian linear scheme, a decision forest scheme, a fast forest quantile scheme, a neural network scheme, a Poisson scheme, and an ordinal scheme.

18. A computer-readable memory device with instructions stored thereon to provide audience targeted filtering of content sections, the instructions composing:
receiving a request to provide content to through a display device;
identifying an audience category of the audience to stream the content to;
if the content is available for priori analysis,
analyzing the content to detect one or more sections of the content to filter based on the determined audience category and associated filtering rules,
providing results of the analysis to a requestor of the content,
receiving feedback based on the provided results, and
filtering the one or more sections of the content based on the feedback;
if the content is not available for priori analysis, applying the associated filtering rules to detect and skip or replace the one or more sections of the content; and
streaming the filtered content to the display device.

19. The computer-readable memory device of claim 18, wherein the instructions further comprise:
retrieving an account information associated with an account associated with the requestor;
identifying an age of the requestor from the account information; and
selecting the audience category based on the age of the requestor.

20. The computer-readable memory device of claim 18, wherein the instructions further comprise:
applying the associated filtering rules to metadata associated with the content.
